(19) United States
(12) Patent Application Publication
(10) Pub. No.: US 2016/0077622 A1
(43) Pub. Date: Mar. 17, 2016

(54) TOUCH DEVICE

(71) Applicant: TPK Touch Solutions (Xiamen) Inc., Xiamen (CN)

(72) Inventors: Yuh-Wen Lee, Hsinchu County (TW); Hebo Yang, Xiamen (CN); Jiangping Chen, Xiamen (CN); Hao Chen, Wuhan (CN); Yu Zhang, Xiamen (CN); Liangzhen Xu, Xiamen (CN)

(21) Appl. No.: 14/849,597

(22) Filed: Sep. 10, 2015

(30) Foreign Application Priority Data
Sep. 11, 2014 (CN) 201410460940.9
Feb. 9, 2015 (CN) 201510066803.1

(51) Int. Cl. G06F 3/041; G06F 1/16

(52) U.S. Cl. CPC G06F 3/041; G06F 1/1692; G06F 2203/04103

(57) ABSTRACT

A touch device includes a cover plate, a substrate, a first adhesive layer and a strengthening glue. The cover plate and the substrate each has first and second opposite surfaces and a side surface between the first surface and the second surface. The first adhesive layer is located between the second surface of the cover plate and the first surface of the substrate. A space is formed between the side surface of the first adhesive layer, the second surface of the cover plate and the first surface the substrate a space. The space is filled with the strengthening glue. The cover plate and the substrate are fully bonded to enhance the strength, the compression resistance and the impact resistance of the touch device. Further the accuracy requirement for the first adhesive layer is lowered and the material of the first adhesive layer is saved.

### CROSS REFERENCE TO RELATED APPLICATIONS

This Non-provisional application claims priority under 35 U.S.C. §119(a) to Patent Application No(s). 201410460940.9 filed in People's Republic of China on Sep. 11, 2014 and Patent Application No(s). 20150066803.1 filed in People's Republic of China on Feb. 9, 2015 the entire contents of which are hereby incorporated by reference.

### BACKGROUND OF THE DISCLOSURE

### FIELD OF THE DISCLOSURE

The disclosure relates to touch devices, in particular to touch devices with high strength and impact resistance.

### DESCRIPTION OF THE RELATED ART

An ordinary touch device usually includes a cover plate and a substrate. An object can touch the cover plate to give input. A touch sensing structure is formed on the substrate to sense the touch input. An adhesive layer such as an optical adhesive is utilized between the cover plate and the substrate to bond them together. During a bonding process, due to bonding tolerance, a side surface of the adhesive layer is generally designed to retract at a certain dimension with respect to the side surfaces of the cover plate and the substrate. Thus, it prevents the adhesive layer from protruding from the side surface of the cover plate due to the bonding tolerance and avoids the result of inferior appearance of the touch device.

Because the adhesive layer retracts with respect to the cover plate and the substrate, a gap exists between the side surfaces of the cover plate, the substrate and the adhesive layer. The gap may accumulate dirt, so that the portion of the cover plate corresponding to the gap is not effectively supported by the substrate, and accordingly the strength of the touch device is decreased. Especially as the thickness of the cover plate becomes thinner, for example a thin cover plate made of sapphire, sapphire has high hardness but it is brittle, and thus the compression resistance and the impact resistance are poor. The gap between the cover plate and the substrate causes the cover plate to crack easily, and the strength and the impact resistance of touch device are also poor.

### SUMMARY OF THE DISCLOSURE

The present disclosure provides a touch device of which the strength and the impact resistance is enhanced.

A touch device according to the disclosure comprises a cover plate, a substrate, a first adhesive layer and a strengthening glue. The cover plate has a first surface and a second surface opposite to each other and a side surface adjacent to the first surface and the second surface of the cover plate. The substrate has a first surface and a second surface opposite to each other and a side surface adjacent to the first surface and the second surface of the substrate. The first adhesive layer is located between the second surface of the cover plate and the first surface of the substrate. A space is formed between the side surface of the first adhesive layer, the second surface of the cover plate and the first surface of the substrate. The space is filled with the strengthening glue.

In some embodiments, the strengthening glue extends to partially cover the side surface of the cover plate and the side surface of the substrate.

In some embodiments, the material of the strengthening glue is a liquid glue formed by solidification.

In some embodiments, the viscosity of the strengthening glue is 500˜1200 mPa·s when not solidified, and the hardness of the strengthening glue is D 70˜85 (Shore) after solidified.

In some embodiments, a maximum thickness is defined from the side surface of the cover plate to the outer surface of the strengthening glue, and the range of the maximum thickness is from 50μm to 200μm.

In some embodiments, the range of the maximum thickness is from 80μm to 120μm.

In some embodiments, the touch device further comprises a touch sensing structure disposed on the first surface of the substrate.

In some embodiments, the touch device further comprises a touch sensing structure disposed on the second surface of the substrate.

In some embodiments, the touch device further comprises a touch sensing structure disposed on the second surface of the cover plate.

In some embodiments, the substrate has an opening, the touch device further comprises a fingerprint recognition module disposed in the opening.

In some embodiments, the opening is a through hole formed from the first surface of the substrate to the second surface of the substrate, or is a notch formed inwardly from the side surface of the substrate.

In some embodiments, the first adhesive layer has an abdication hole between the opening of the substrate and the cover plate, and the touch device further comprises a second adhesive layer disposed in the abdication hole and located between the fingerprint recognition module and the cover plate.

In some embodiments, the touch device further comprises a fixing structure, located between the fingerprint recognition module and the substrate to fix the fingerprint recognition module in the opening of the substrate.

In some embodiments, the fixing structure and the strengthening glue are glues of same material.

In some embodiments, the touch device further comprises a mask layer disposed on the second surface of the cover plate, and its vertical projection onto the cover plate at least covers the vertical projection of the fingerprint recognition module onto the cover plate.

In some embodiments, the touch device further comprises a shielding structure located between the cover plate and the substrate and surrounding the fingerprint recognition module.

In some embodiments, the shielding structure is located between the first adhesive layer and the substrate.

In some embodiments, the shielding structure is located between the cover plate and the mask layer.

In some embodiments, the thickness of the cover plate is smaller than or equal to 0.3 mm.

In some embodiments, the thickness of the cover plate is from 0.2 mm to 0.3 mm.

In some embodiments, the material of the cover plate is transparent glass, sapphire, the composite structure of glass/sapphire, the composite structure of glass/glass, or the composite structure of sapphire/sapphire, and the material of the substrate is transparent glass.

In some embodiments, the cover plate has an indentation, and the orthographic projections of the indentation and the fingerprint recognition module onto the cover plate overlap.

In some embodiments, the indentation caves in from the first surface of the cover plate to the second surface of the cover plate.

In some embodiments, a depth from the first surface of the cover plate to the lowest point of the indentation is smaller than or equal to 1.7 mm.

In some embodiments, the depth is larger than or equal to 0.02 mm and smaller than or equal to 0.55 mm.

In some embodiments, the depth is larger than or equal to 0.05 mm and smaller than or equal to 0.45 mm.

In some embodiments, a minimum distance from the lowest point of the indentation to the fingerprint recognition module is larger than or equal to 15μm and smaller than or equal to 550μm.

In some embodiments, the minimum distance is larger than or equal to 80μm and smaller than or equal to 400μm.

In some embodiments, the indentation has a bottom surface and at least one lateral surface adjacent to the bottom surface, and the included angle between the bottom surface and the lateral surface is larger than 90° and smaller than 180°.

In some embodiments, the indentation has two adjacent lateral surfaces, and the included angle between the two lateral surfaces is larger than 90° and smaller than 180°.

In some embodiments, the indentation is an arc surface, one edge of the arc surface is adjacent to the side surface of the cover plate, and the other opposite edge is adjacent to the first surface of the cover plate.

As to the touch device according to the disclosure, because the space between the side surface of the first adhesive layer, the second surface of the cover plate and the first surface of the substrate is filled with a strengthening glue, the space between the cover plate and the substrate is fully filled with the strengthening glue combined with the first adhesive layer. Accordingly the cover plate and the substrate are fully bonded to enhance the strength and the impact resistance of the touch device. Furthermore, the accuracy requirement for the first adhesive layer is lowered and the material of the first adhesive layer is saved.

Moreover, the strengthening glue can further cover the side surfaces of the cover plate and the substrate to increase the contact area between the strengthening glue, the cover plate and the substrate. Accordingly, the adhesive force between the strengthening glue, the cover plate and the substrate can be improved, and the external force is buffered for the cover plate and the side surface of the substrate and they are protected.

### BRIEF DESCRIPTION OF THE DRAWINGS

The embodiments will become more fully understood from the detailed description and accompanying drawings, which are given for illustration only, and thus are not limitative of the present disclosure, and wherein:

FIG. 1A is a schematic structure diagram showing the touch device according to some embodiments of the disclosure;

FIG. 1B is a schematic structure diagram showing the touch device according to some embodiments of the disclosure;

FIG. 2A is a schematic structure diagram showing the touch device according to some embodiments of the disclosure;

FIG. 2B is a schematic structure diagram showing the touch device according to some embodiments of the disclosure;

FIG. 3 is a top view showing the touch device according to some embodiments of the disclosure;

FIG. 4A and FIG. 4B are top views respectively showing the substrate of the touch device according to different embodiments of the disclosure;

FIG. 5 is a sectional view along the sectional line I-I′ in FIG. 3;

FIG. 6 is a sectional view of the touch device according to some embodiments of the disclosure;

FIG. 7 is a schematic structure diagram showing the shielding structure in the touch device according to some embodiments of the disclosure;

FIG. 8A to FIG. 8C are sectional views of the cover plate of the touch device along the sectional line I-I′ in FIG. 3 according, to the different embodiments of the disclosure;

FIG. 8D is a perspective view showing the cover plate of the touch device according to some embodiments of the disclosure;

FIG. 8E is a sectional views of the cover plate of the touch device along the sectional line B-B′ in FIG. 8D according to some embodiments of the disclosure; and

FIG. 9 is a sectional views of the touch device along the sectional line I-I′ in FIG. 3 according to some embodiments of the disclosure.

### DETAILED DESCRIPTION OF THE DISCLOSURE

The embodiments of the disclosure will be apparent from the following detailed description, which proceeds with reference to the accompanying drawings.

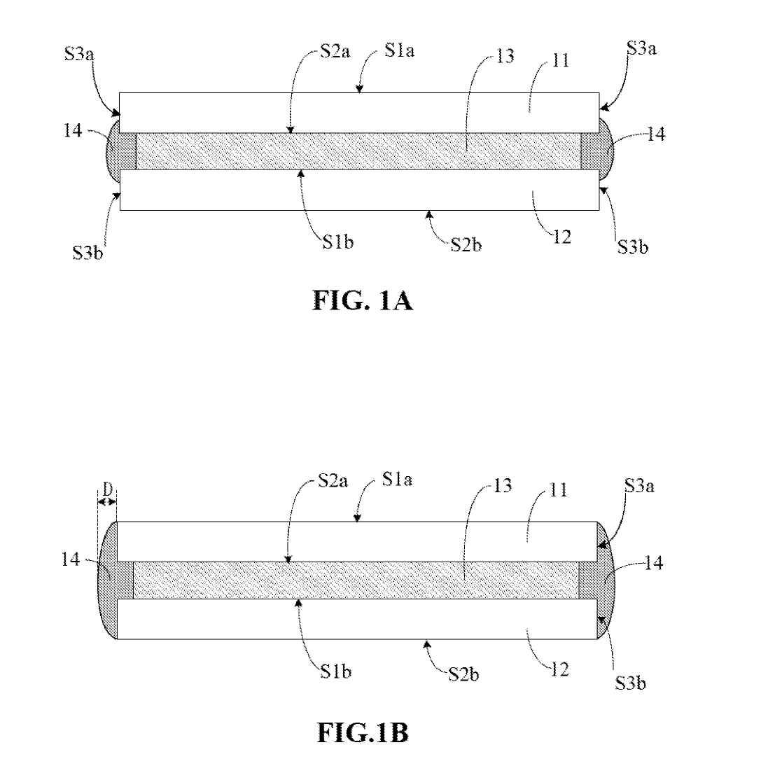

In the following embodiments, the terms of “on”, “above”, “over”, “upper”, “top”, “under”, “underneath”, “below”, “lower”, “lowest” and “bottom” are used to describe relative positions. In FIG. 1A to FIG. 7, “top” refers to locations closer to the user and “bottom” refers to locations farther from the user, but these orientation descriptions should not limit the scope of the embodiments of the disclosure. It is also noted that like reference numerals refer to like elements.

Referring to FIG. 1A, FIG. 1A is a schematic structure diagram showing a touch device according to some embodiments of the disclosure. The touch device includes a cover plate 11, a substrate 12, a first adhesive layer 13, and a strengthening glue 14.

The cover plate 11 has a first surface S1a, a second surface S2a and a side surface S3a. The user can directly touch the first surface S1a to operate the touch device. Namely, the first surface S1a of the cover plate 11 is closer to the user than the second surface S2a. The second surface S2a and the first surface S1a are opposite to each other, and the side surface S3a is adjacent to the first surface S1a and the second surface S2a. On the first surface S1a of the cover plate 11, one layer or multiple layers of functional films can be disposed, for example antireflective film, anti-glare film or antireflection coating film, etc. The cover plate 11 protects the elements formed below it. In some embodiments, the material of the cover plate 11 is transparent material. In some embodiments, the transparent material is glass, sapphire, inflexible plastic, or the like. Further, the cover plate 11 may be the composite structure of glass/sapphire, glass/glass, or sapphire/sapphire. For better touch sensitivity, the thickness of the cover plate 11 is preferably smaller than or equal to 0.3 mm. Regarding the manufacturing cost and difficulty, the thickness of the cover plate 11 is preferably from 0.2 mm to 0.3 mm.

The substrate 12 has a first surface S1b, a second surface S2b and a side surface S3b. The first surface S1b and the second surface S2b are opposite to each other. The substrate 12 and the cover plate 11 overlap. The first surface S1b is closer to the second surface S2a of the cover plate 11. In some embodiments, a touch module or a display module (not shown in the figure) is bonded at one side of the second surface S2b to form the touch device or the touch display device. The cover plate 11 and the substrate 12 are combined to be the composite cover plate of the touch device or the touch display device. The side surface S3b is located between the first surface S1b and the second surface S2b as the outer end face of the substrate 12. The substrate 12 can support the cover plate 11 to enhance the strength of the cover plate 11. In addition, a touch sensing structure can be formed on the substrate 12, and the structure of the touch sensing structure will be described later. The material of the substrate 12 can be the same transparent material as that of the cover plate 11, for example glass or inflexible plastic.

The first adhesive layer 13 is located between the second surface S2a of the cover plate 11 and the first surface S1b of the substrate 12 to bond the cover plate 11 and the substrate 12. The side surface of the first adhesive layer 13 retracts with respect to the side surfaces S3a. S3b of the cover plate 11 and the substrate 12. Namely, a space is formed between the side surface of the first adhesive layer 13, the second surface S2a of the cover plate 11 and the first surface S1b of the substrate 12. The size of the space is adjustable depending on the bonding tolerance or the design requirement. The first adhesive layer 13 may be transparent optical glue, for example solid optical glue or liquid optical glue.

The space between the side surface of the first adhesive layer 13, the second surface S2a of the cover plate 11 and the first surface S1b of the substrate 12 is filled with the strengthening glue 14. The strengthening glue 14 combined with the first adhesive layer 13 fully bonds the cover plate 11 and the substrate 12. Namely the space between the cover plate 11 and the substrate 12 is fully filled with the glue. Because the space mentioned above is filled with the strengthening glue 14, the accuracy requirement for the first adhesive layer 13 can be lowered to save the material of the first adhesive layer 13 when the first adhesive layer 13 bonds the cover plate 11 and the substrate 12. Because the cover plate 11 and the substrate 12 are fully bonded, the substrate 12 better supports the cover plate 11. When the thickness of the cover plate 11 is thinner, the strength of the cover plate 11 is also enhanced, which prevents rupture.

In other embodiments, the strengthening glue 14 can further extend to partially cover the side surface S3a of the cover plate 11 and the side surface S3b of the substrate 12, or alternatively the side surface S3a of the cover plate 11 and the side surface S3b of the substrate 12 are fully covered by the strengthening glue 14 as shown in FIG. 1B. Therefore, at least one part of the side surfaces S3a. S3b of the cover plate 11 and the substrate 12 is covered by the strengthening glue 14 to increase the contact area between the strengthening glue 14, the cover plate 11 and the substrate 12 so as to improve the adhesive force. Furthermore, the strengthening glue 14 can buffer the external force and protect the side surfaces S3a, S3b of the cover plate 11 and the substrate 12 from scrapes or fragmentation during follow-up processing or assembling.

The material of the strengthening glue 14 may be a liquid glue formed by solidification, for example an ultraviolet (UV) glue. For example, when the strengthening glue 14 is liquid, it may be formed in the space and on the side surfaces S3a. S3b of the cover plate 11 and the substrate 12 by injection molding, adhesive, spraying or roller coating, etc. After solidifying, the strengthening glue 14 is tightly and securely bonded to the space and the side surfaces S3a, S3b of the cover plate 11 and the substrate 12 mentioned above. Moreover, when the side surfaces S3a, S3b of the cover plate 11 and the substrate 12 have a little crack or gap, capillary action may occur between the strengthening glue 14 in the liquid state and the side surfaces S3a, S3b of the cover plate 11 and the substrate 12, so the strengthening glue 14 can repair small cracks or gaps to enhance the strength of the cover plate 11 and the substrate 12, the compression resistance and the impact resistance. The viscosity of the strengthening glue 14 is 500˜1200 CPS (mPa·s) when not solidified, and the hardness of the strengthening glue is D 70˜85 (Shore) after solidification. Because the strengthening glue 14 is formed from solidified liquid glue, the outer surface of the strengthening glue 14, namely the outer surface against the cover plate 11, the substrate 12 and the first adhesive layer 13, is usually an arc surface. A maximum thickness D is defined from the side surface S3a of the cover plate 11 to the outer surface of the strengthening glue 14 (as shown in FIG. 1B), and the range of the maximum thickness D is from 50μm to 200μm, preferably from 80μm to 120μm. The strengthening glue 14 of such designed thickness can better buffer the external force and protect the side surfaces S3a, S3b of the cover plate 11 and the substrate 12.

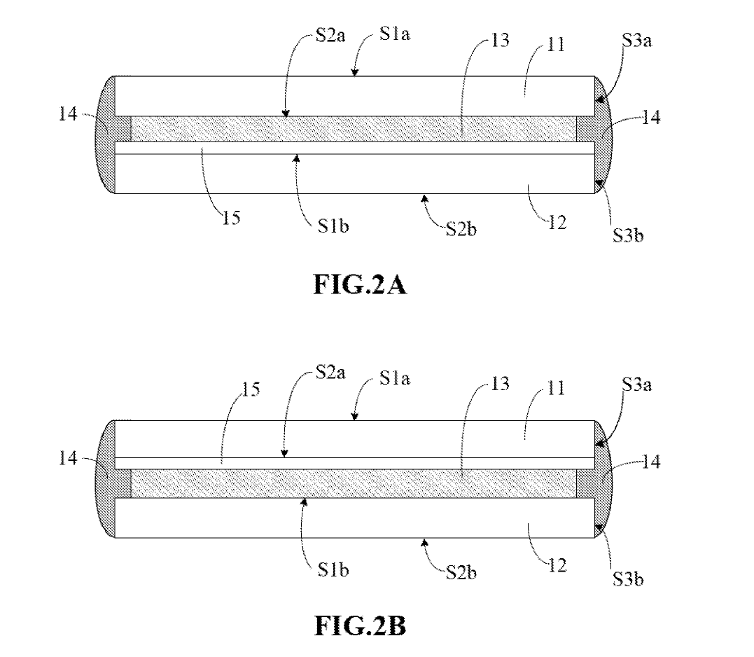

The touch device may further include a touch sensing structure capable of sensing touch input. The touch sensing structure in different embodiments is disposed at different layers. Referring to FIG. 2A and FIG. 2B respectively, FIG. 2A is a schematic structure diagram showing the touch sensing structure disposed on the substrate 12, and FIG. 2B is a schematic structure diagram showing the touch sensing structure disposed on the cover plate 11.

Referring to FIG. 2A, a touch sensing structure 15 is disposed on the first surface S1b of the substrate 12. In detail, the touch sensing structure 15 is located between the first adhesive layer 13 and the substrate 12. The touch sensing structure 15 can be a conductive structure of single layer or multiple layers. The conductive structure may include uniaxial, biaxial or multiaxial electrode patterns. The material of the electrode patterns may include transparent indium tin oxide (ITO), nano silver, graphene, carbon nanotubes, metal mesh or other conductive material, or one or more than one material thereof. The touch sensing structure 15 may be directly formed on the first surface S1b of the substrate 12 by lithography etching or printing. Alternatively, the touch sensing structure 15 may be a conductive structure of a flexible thin film. The conductive structure of thin film may be attached to the substrate 12 by bonding. In other embodiments, the touch sensing structure 15 is further located at the second surface S2b of the substrate 12 (not shown in the figure). In detail, the substrate 12 is located between the first adhesive layer 13 and the touch sensing structure 15.

Besides, referring to FIG. 2B, the touch sensing structure 15 can be further disposed on the second surface S2a of the cover plate 11. In detail, the touch sensing structure 15 is located between the cover plate 11 and the first adhesive layer 13. The touch sensing structure 15 may be directly formed on the second surface S2a or the cover plate 11 by lithography etching or printing; or alternatively, the touch sensing structure 15 may be a conductive structure of flexible thin film, and the conductive structure of thin film may be attached to the second surface S2a of the cover plate 11 by bonding. Because the structure and the material of the touch sensing structure 15 can refer to the embodiment of FIG. 2A, they are not repeated here.

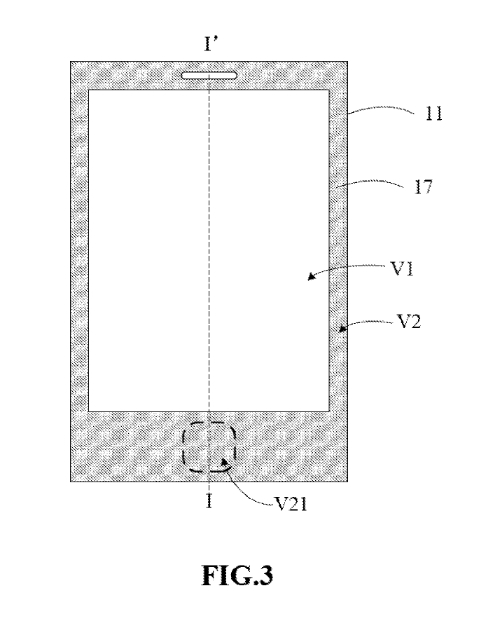

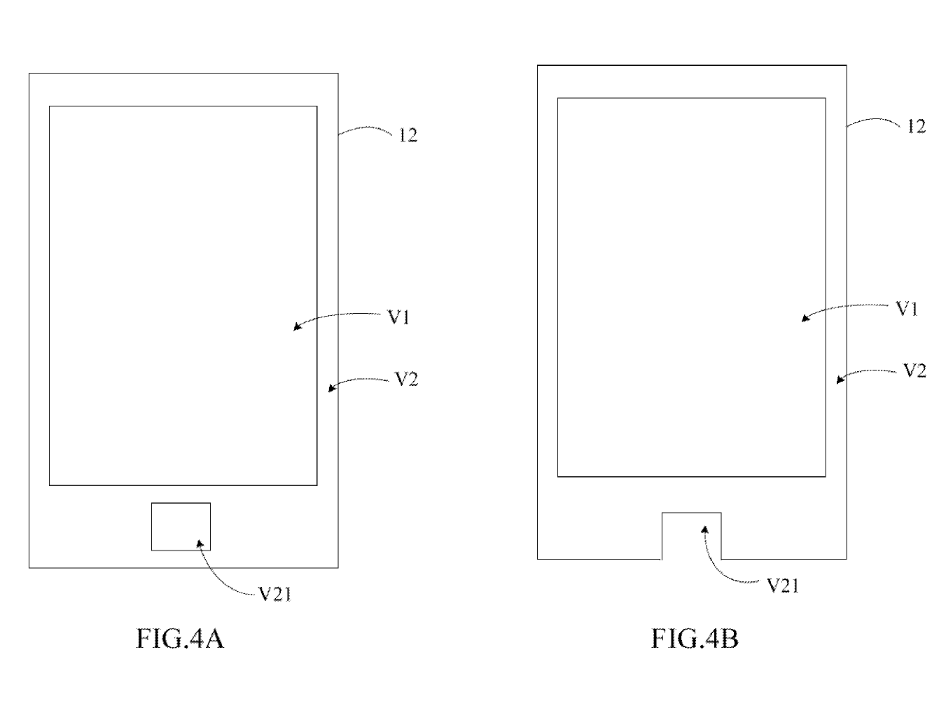

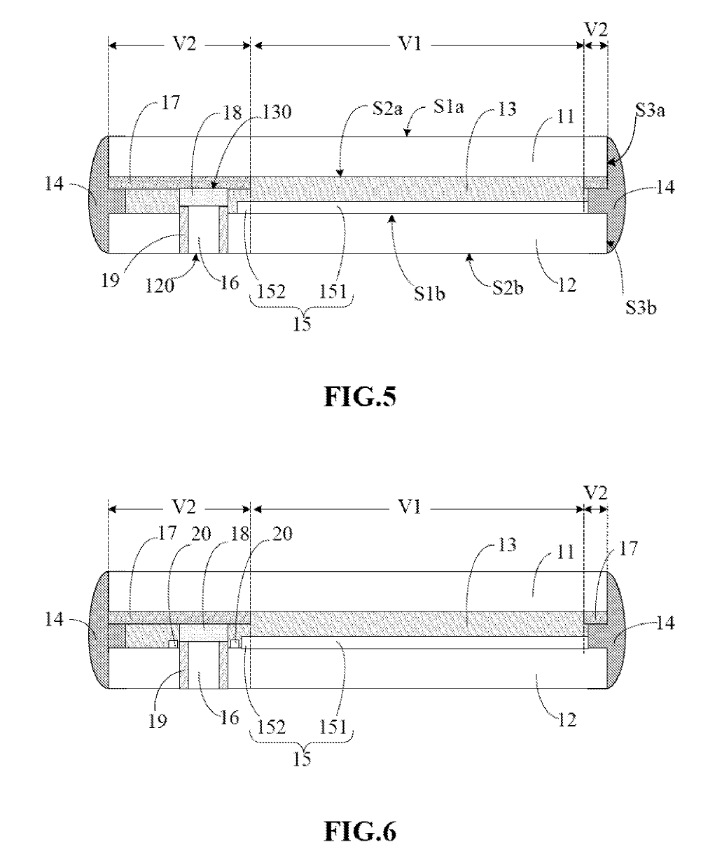

In some embodiments, the touch device may be further capable of recognizing a fingerprint. By recognizing the fingerprint, the touch device may complete cold screen, awakening, and unlock at one time to enhance the user experience. FIG. 3 is a top view showing the touch device capable of recognizing the fingerprint. FIG. 4A and FIG. 4B are top views respectively showing the different structure of the substrate of the touch device. FIG. 5 is a sectional view along the sectional line I-I′IN FIG. 3. Referring to FIG. 3 to FIG. 5, the touch device includes the cover plate 11, the substrate 12, a first adhesive layer 23, the strengthening glue 14, the touch sensing structure 15 and a fingerprint recognition module 16. The following describes differences compared to the embodiment of FIG. 1B, with description of same or similar structures not repeated here.

A mask layer 17 is disposed on the second surface S2a. of the cover plate 11. The mask layer 17 is located between the cover plate 11 and the first adhesive layer 13. The mask layer 17 distinguishes a visible region V1 from a non-visible region V2 on the cover plate 11. The area Where the mask layer 17 is located is regarded as the non-visible region V2. The area which is touched by the user and adapted to display image by the display device is regarded as the visible region V1. Generally, the non-visible region V2 is located on at least one side of the visible region. In some embodiments, the non-visible region V2 surrounds the visible region V1, for example, but it is not limited thereto. The mask layer 17 is usually formed by opaque ink, photoresist, etc. so that the a frame appears on the touch device to shield some opaque elements under the cover plate 11, for example the fingerprint recognition module, flexible printed circuit board and conductive wiring, etc. The mask layer 17 may be a single-layer structure, or alternatively may be a multiple-layer structure formed by stacking multiple layers of material. The thickness of the mask layer 17 is less than or equal to 20μm. Regarding the shielding effect of the mask layer 17 and the impact on the sensitivity of the fingerprint recognition, the thickness of the mask layer 17 is for example from 1μm to 10μm.

The substrate 12 has an opening 120 (see FIG. 5). The opening 120 is a through hole formed from the first surface S1b of the substrate 12 to the second surface S2b of the substrate 12 (as shown in FIG. 4A), or it is a notch formed inwardly from the side surface S3b of the substrate 12 (as shown in FIG. 4B). The opening 120 is located at the non-visible region V2 and it is hidden. by the mask layer 17. It is noted that if the opening 120 of the substrate 12 is the through hole, the strengthening glue 14 preferably covers the side surface S3b of the substrate 12. If the opening of the substrate 12 is the notch, the strengthening glue 14 would avoid the notch and it only covers the portions of the side surface S3b other than the notch of the substrate 12. In some embodiments, the material of the substrate 12 is the same as that of the substrate in FIG. 1B.

Referring to FIG. 3 to FIG. 5, the fingerprint recognition module 16 is disposed in the opening 120 of the substrate 12 and located at the non-visible region V2. The area which the fingerprint recognition module 16 corresponds to may be defined as a fingerprint recognition area V21. The vertical projection of the mask layer 17 onto the cover plate 11 at least covers the vertical projection of the fingerprint recognition module 16 onto the cover plate 11. Namely, the fingerprint recognition area V21 is located within the non-visible region V2 to guarantee aesthetics of the touch device. In some embodiments, the first adhesive layer 13 has an hole 130 between the opening 120 of the substrate 12 and the cover plate 11. The hole 130 corresponds to the fingerprint recognition area V21. A second adhesive layer 18 is disposed in the hole 130, and farther located between the fingerprint recognition module 16 and the cover plate 11. By the second adhesive layer 18, the fingerprint recognition module 16 is bonded to the second surface S2a of the cover plate 11. The second adhesive layer 18 is formed by explosion-proof optical glue, and its thickness is thinner than that of the first adhesive layer 13. The thickness of the second adhesive layer 18 is smaller than or equal to 50μm, preferably from 3μm to 30μm. To further enhance the sensitivity of the fingerprint recognition, the thickness of the second adhesive layer 18 is smaller than or equal to 10μm. Compared with the general optical glue, the second adhesive layer 18 has less shielding effect on electrical signals. When the second adhesive layer 18 is disposed between the cover plate 11 and the fingerprint recognition module 16, the second adhesive layer 18 can fix and reduce attenuation of small signal between the cover plate 11 and the fingerprint recognition module 16, and accordingly causes less impact on the sensitivity of the fingerprint recognition module 16. Preferably, the touch device further includes the fixing structure 19 located between the fingerprint recognition module 16 and the substrate 12 to fix the fingerprint recognition module 16 securely in the opening 120 of the substrate 12. Preferably, because the fixing structure 19 is liquid and a glue capable of flowing, the space between the sidewall of the opening 120 of the substrate 12 and the fingerprint recognition module 16 is flexibly filled with the fixing structure 19, so as to avoid a residual gap between the fingerprint recognition module 16 and the substrate 12 which may impact the compression resistance and the impact resistance of the cover plate 11. In some embodiments, the fixing structure 19 and the strengthening glue 14 are glues of the same material. The manners for fixing the fingerprint recognition module 16 in the opening 120 of the substrate 12 are not limited to fixing by the second adhesive layer 18 and/or the fixing structure 19, and may be implemented by other manners, for example fixing by auxiliary elements or by engagement of the size or shape of the opening 120.

Besides, to enhance the adhesion of the fingerprint recognition module 16 to the mask layer 17, or to reduce the damage to or the scrapes on the fingerprint, recognition module 16 during follow-up assembling or processing, the fixing structure 19 not only covers the lateral surface of the fingerprint recognition module 16, but also further covers the bottom surface of the fingerprint recognition module 16.

In some embodiments, the fixing structure 19, the second adhesive layer 18, the space between the cover plate 11, the substrate 12 and the fingerprint recognition module 16 are completely filled with the first adhesive layer 13 combined with the strengthening glue 14 to fully laminated the above three. Especially, when the cover plate 11 is the thinner cover plate of sapphire and its thickness is usually smaller than or equal to 0.3 mm, both the edge area of the cover plate 11 and the fingerprint recognition area V21 have better strength to prevent rupturing of the cover plate 11 and enhance the compression resistance and the impact resistance of the touch device.

Moreover, by distinguishing the fingerprint recognition area V21 from other portions of the non-visible region V2, the user can more accurately and easily touch the fingerprint recognition area. V21 to perform fingerprint recognition. In some embodiments, the mask layer 17 is partially hollowed, and the hollowed portion is filled with the shielding material which is distinct from the mask layer 17 in color to forum an indication icon for indicating the fingerprint recognition area. Alternatively, in the fingerprint recognition area V21 between the mask layer 17 and the cover plate 11, a different color icon from the mask layer is sandwiched for indicating the fingerprint recognition area V21.

The touch sensing structure 15 is disposed on the first surface S1b of the substrate 12, namely located between the first adhesive layer 13 and the substrate 12. In detail, the touch sensing structure 15 includes an electrode layer 151 located in the visible region V1 and a wiring layer 152 located in the non-visible region V2. The electrode layer 151 is adapted to generate a touch signal according to the touch operation, and the wiring layer 152 transmits the touch signal to the controller to compute the location of the touch. The electrode layer 151 can be a single- or multi-layer conductive structure. The conductive structure may include uniaxial, biaxial or multiaxial electrode patterns. The material of the electrode patterns may include transparent indium tin oxide (ITO), nano silver, graphene, carbon nanotubes metal mesh or other conductive material, or one or more than one material thereof. The touch sensing structure 15 may be directly formed on the first surface S1b of the substrate 12 by lithography etching or printing; or alternatively, the touch sensing structure 15 may be a conductive structure of flexible thin film, and the conductive structure of thin film may be attached to the substrate 12 by bonding. In some embodiments, the touch sensing structure 15 can be further located at the second surface S2b of the substrate 12 (not shown in the figure). In detail, the substrate 12 is located between the first adhesive layer 13 and the touch sensing structure 15. Alternatively, the touch sensing structure 15 may be similar to that shown in FIG. 2B disposed on the second surface 52a of the cover plate 11.

In some embodiments, the touch device integrates the function of fingerprint recognition to enhance user experience. Moreover, the fingerprint recognition module 16 is disposed in the opening 120 of the substrate 12 and bonded to the complete cover plate 11 to form the touch device capable of fingerprint recognition. It is unnecessary to bore a hole on the cover plate 11, so the strength of the cover plate 11 is not impacted, ensuring product performance. Besides, location of the fingerprint recognition module 16 in the touch device is not restricted to a movable button, but is flexible, and accordingly a complicated package structure for the movable button is omitted. While guaranteeing fingerprint recognition functionality, product structure is simplified and design of the product is more flexible.

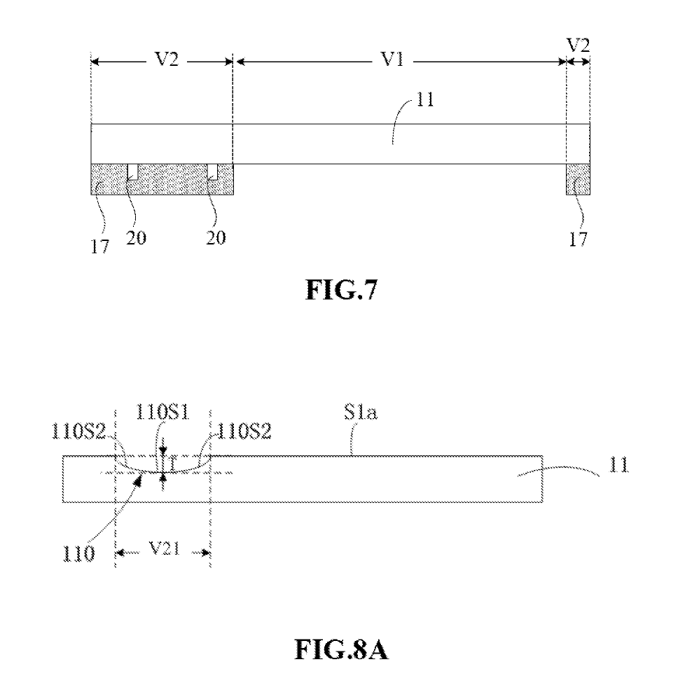

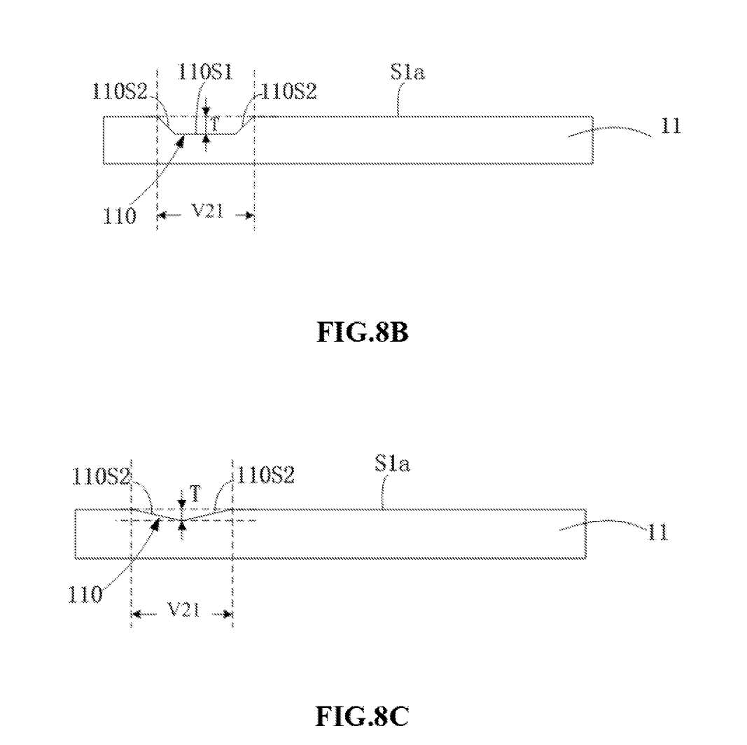

Referring to FIG. 6, FIG. 6 is a sectional view of the touch device according to some embodiments of the disclosure. The difference between FIG. 6 and FIG. 5 is that the touch device further includes a shielding structure 20 which is located between the cover plate 11 and the substrate 12 and surrounds the fingerprint recognition module 16. The shielding structure 20 is adapted to shield the fingerprint recognition module 16 from electromagnetic noise. In some embodiments, the shielding structure 20 is a ring-shaped metal structure disposed on the surface of the substrate 12 and located between the substrate 12 and the first adhesive layer 13. It is noted that in other embodiments, such as FIG. 7, the shielding structure 20 is disposed between the cover plate 11 and the first adhesive layer 13.

Referring to FIG. 7, FIG. 7 is a schematic structure diagram showing the shielding structure in the touch device according to various embodiments of the disclosure. For the sake of clarity in illustrating the shielding structure 20, some elements of the touch device are omitted in FIG. 7. But it should be appreciated that the omitted elements are roughly the same or similar to those in the FIG. 6. The shielding structure 20 is disposed on the second surface S2a of the cover plate 11 and located between the cover plate 11 and the mask layer 17. Because the shielding structure 20 is formed by metal material, the color of the shielding structure 20 is distinct from the mask layer 17. When disposed between the cover plate 11 and the mask layer 17, the shielding structure 20 is adapted to indicate the fingerprint recognition area so that the user can see the shielding structure 20 from the touch operation surface. Therefore, other indication icons may be omitted. The shielding structure 20 may be formed on the second surface S2a of the cover plate 11 by sputtering or printing.

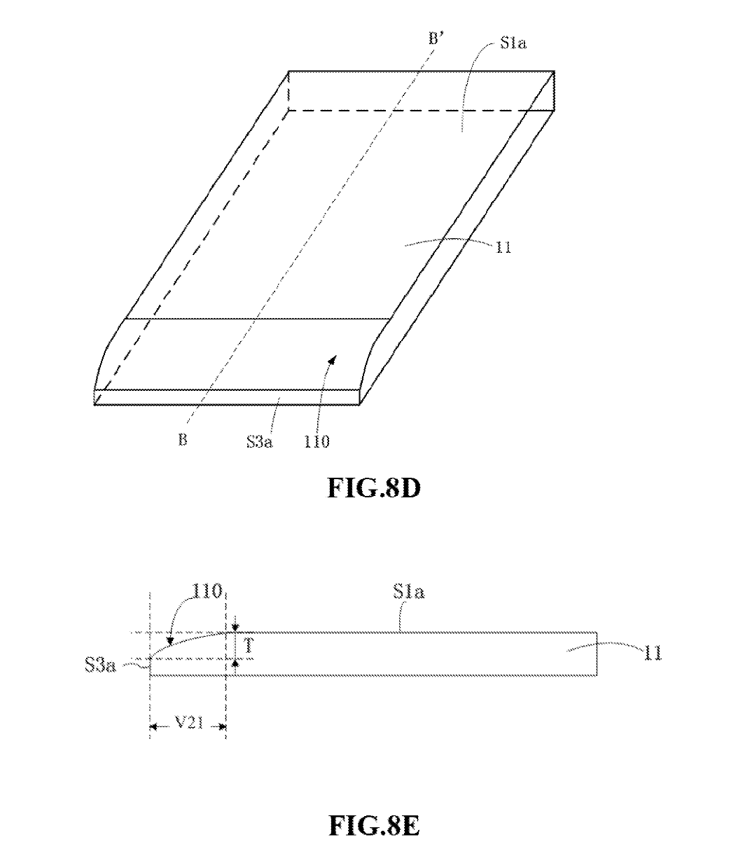

Referring to FIG. 8A to FIG. 8E, FIG. 8A to FIG. 8C are sectional views of the cover plate of the touch device along the sectional line I-I′ in FIG. 3 according to various embodiments of the disclosure. FIG. 8D is a perspective view showing the cover plate of the touch device according to various embodiments of the disclosure. FIG. 8E is a sectional views of the cover plate of the touch device along the sectional line B-B′ in FIG. 8D according to various embodiments of the disclosure. The cover plate 11 has an indentation 110. The orthographic projections of the indentation 110 and the fingerprint recognition module onto the cover plate 11 overlap. In some embodiments, the fingerprint recognition area V21 caves in from the first surface S1a of the cover plate 11 (the surface adapted to touch or operation by the user) to the second surface S2a of the cover plate 11 to form the indentation 110. The user can give input of fingerprint on the indentation 110 by pressing or swiping.

Referring to FIG. 8A and FIG. 8B, the indentation 110 has a bottom surface 110S1 and a lateral surface 110S2. The bottom surface 110S1 is adjacent to the lateral surface 110S2, and the lateral surface 110S2 connects to the first surface S1a of the cover plate 11. The included angle between the bottom surface 110S1 and the lateral surface 110S2 is larger than 90° and smaller than 180°. It is noted that in FIG. 8A for example, the indentation 110 is a solid notch of which the sectional shape is an arc, and its bottom surface 110S1 and lateral surface 110S2 are both curved surfaces. The included angle between the bottom surface 110S1 and the lateral surface 110S2 refers to the included angle between the tangent of the lowest point of the bottom surface 110S1 and the tangent of the lateral surface 110S2. In FIG. 8B for example, the indentation 110 is a solid notch of which the sectional shape is a trapezoid, and bottom surface 110S1 and lateral surface 110S2 of the indentation 110 are both flat. However, they are not limited thereto. One of the bottom surface 110S1 and the lateral surface 110S2 may be a curved surface.

In FIG. 8C, the indentation 110 has two adjacent lateral surfaces 110S2, and the point of the intersection of the two lateral surfaces 110S2 is the lowest point of the indentation 110. The included angle between the two lateral surfaces 110S2 is larger than 90° and smaller than 180°, and the indentation 110 is a solid notch of which the sectional shape is V-shaped, for example.

Referring to FIG. 8D and FIG. 8E, the indentation 110 is an arc surface, one edge of the arc surface is adjacent to the side surface S3a of the cover plate 11, and the other opposite edge is adjacent to the first surface S1a of the cover plate 11. It is noted that from FIG. 8A to FIG. 8C, the first surface S1a caves in at the fingerprint recognition area V21 to the second surface S2a. On the other hand, for manufacturing convenience and better appearance of the touch device, the indentation 110 in FIG. 8D may be formed by processing one end of the cover plate 11 together with the side surface S3a and the partial first surface S1a. Referring to FIG. 8E, the indentation 110 is formed by bending from one end of the first surface S1a to the side surface 53a and the second surface S2a. In other embodiments, the indentation 110 is formed by bending from one end of the first surface S1a to the second surface S2a and thus connected to the second surface S2a. At the junction where the first surface S1a partially bends to connect to the second surface S2a, an angle of chamfer can be further disposed to smooth the junction. Therefore, the visual appearance and ergonomics of the touch device can be improved.

Moreover, in FIG. 8A to FIG. 8E, to mitigate the impact on the strength and the appearance of the cover plate 11 due to forming the indentation 110, a depth T from the first surface S1a of the cover plate 11 to the lowest point of the indentation 110 is smaller than or equal to 1.7 mm; Furthermore, it is larger than or equal to 0.02 mm and smaller than or equal to 0.55 mm: preferably, it is larger than or equal to 0.05 mm and smaller than or equal to 0.45 mm. A suitable range of the depth T depends on the application field of the touch device, such as automotive, mobile terminals, notebook computers, etc. For example, the depth T would be relatively larger if applied to a car. The depth T would be relatively smaller if applied to a mobile terminal such as mobile phone, etc. In FIG. 8A, the depth T is the vertical distance from the first surface S1a to the tangent to the lowest point of the solid notch of curved shape. In the embodiment of FIG. 8B, the depth T is the vertical distance from the first surface S1a to the bottom surface 110S1. In the embodiment of FIG. 8C, the depth T is the vertical distance from the first surface S1a to the junction of the two lateral surfaces 110S2. In FIG. 8D and FIG. 8E, the depth T is the vertical distance from the first surface S1a to the junction of the arc surface and the edge of the side surface S3a.

The indentation 110 contributes to intuitively indicating, the fingerprint recognition area V21, and also reduces the distance from the touch surface to the fingerprint recognition module 16 to enhance the sensitivity of fingerprint recognition. Besides, benefiting from the indentation 110, the cover plate 11 is thinner only at the portion where the indentation 110 is located, but other portions maintain relatively thicker thickness to increase or maintain the strength of the cover plate 11.

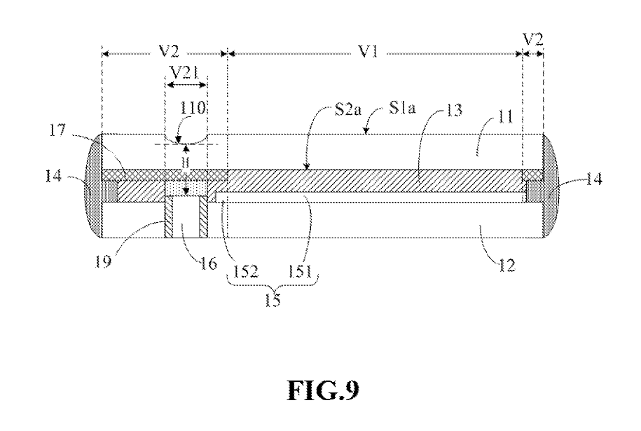

FIG. 9 is a sectional view of the touch device along the sectional line I-I′ in FIG. 3 according to various embodiments of the disclosure. A number of similarities exist between FIG. 9 and FIG. 5, so the following description primarily covers the differences.

In some embodiments, the cover plate 11 may refer to the cover plate having the indentation 110 in FIG. 8A. It should be appreciated that the cover plate 11 may be any one structure of the cover plate in the previous embodiments of FIG. 8B to FIG. 8E. Because the structure and dimensions of the indentation 110 can refer to the previous description, they are not repeated here.

For the fingerprint recognition module 16 to detect the fingerprint operated on the cover plate 11 more sensitively, the minimum distance H between the lowest point of the indentation 110. and the top surface of the fingerprint recognition module 16 can be between 50μm to 450μm. In some embodiments, the minimum distance H can be between 80μm to 400μm, for example 220μm, 280μm, 300μm, etc. The top surface of the fingerprint recognition module 16 is the closer surface of the fingerprint recognition module 16 to the lowest point of the indentation 110. It is noted that on the first surface S1a of the cover plate 11, one layer or multiple: layers of functional films can be disposed, for example antireflective film, anti-glare film or antireflection coating film, etc. When at least one additional functional film is disposed

on the first surface S1a, the minimum distance H is the minimum distance from the actual touch surface touched by the object to the top surface of the fingerprint recognition module 16, namely the minimum distance from the surface of the functional film against the surface of the cover plate 11 to the top surface of the fingerprint recognition module 16. Benefiting from reasonable depth T and minimum distance H of the indentation 110, the sensitivity of fingerprint recognition is enhanced maximally and the strength of the cover plate 11 at the fingerprint recognition area V21 is still taken into account.

As to the touch device according to the disclosure, because the space between the side surface of the first adhesive layer, the second surface of the cover plate and the first surface of the substrate is filled with a strengthening glue, the space between the cover plate and the substrate is fully filled with the strengthening glue combined with the first adhesive layer. Accordingly, the cover plate and the substrate are fully bonded to enhance the strength and the impact resistance of the touch device. Furthermore, the accuracy requirement for the first adhesive layer is lowered and the material of the first adhesive layer is saved.

Moreover, the strengthening glue can further cover the cover plate and the side surface of the substrate to increase the contact area between the strengthening glue, the cover plate and the substrate. Accordingly, the adhesive force between the strengthening glue, the cover plate and the substrate can be raised, and the external force is buffered for the cover plate and the side surface of the substrate and they are protected.

Although the disclosure has been described with reference to specific embodiments, this description is not meant to be construed in a limiting sense. Various modifications of the disclosed embodiments, as well as alternative embodiments, will be apparent to persons skilled in the art. It is therefore, contemplated that the appended claims will cover all modifications that fall within the true scope of the disclosure.

What is claimed is:

1. A touch device, comprising:
a cover plate, having a first surface and a second surface opposite to each other, and further having a side surface adjacent to the first surface and the second surface of the cover plate;
a substrate, having a first surface and a second surface opposite to each other, and further having a side surface adjacent to the first surface and the second surface of the substrate;
a first adhesive laver, located between the second surface of the cover plate and the first surface of the substrate, wherein a space is formed between the side surface of the first adhesive layer, the second surface of the cover plate and the first surface of the substrate; and
a strengthening glue, wherein the space is filled with the strengthening glue.

2. The touch device of claim 1, wherein the strengthening glue extends to partially cover the side surface of the cover plate and the side surface of the substrate.

3. The touch device of claim 1, wherein the material of the strengthening glue is a liquid glue formed by solidification.

4. The touch device of claim 3, wherein the viscosity of the strengthening glue is 500˜1200 mPa·s when not solidified, and the hardness of the strengthening glue is D 70˜85 (Shore after solidified.

5. The touch device of claim 1, wherein a maximum thickness is defined from the side surface of the cover plate to the outer surface of the strengthening glue, and the range of the maximum thickness is from 50μm to 200μm.

6. The touch device of claim 5, wherein the range of the maximum thickness if from 80μm to 120μm.

7. The touch device of claim 1, further comprising:
a touch sensing structure, disposed on the first surface of the substrate or disposed on the second surface of the substrate or disposed on the second surface of the cover plate.

8. The touch device of claim 1, wherein the substrate has an opening, the touch device further comprises a fingerprint recognition module disposed in the opening.

9. The touch device of claim 8, wherein the opening is a through hole formed from the first surface of the substrate to the second surface of the substrate, or is a notch formed inwardly from the side surface of the substrate.

10. The touch device of claim 8 wherein the first adhesive layer has an abdication hole between the opening of the substrate and the cover plate, and the touch device further comprises a second adhesive layer disposed in the abdication hole and located between the fingerprint recognition module and the cover plate.

11. The touch device of claim 8, further comprising:
a fixing structure, located between the fingerprint recognition module and the substrate to fix the fingerprint recognition module in the opening of the substrate.

12. The touch device of claim 11, wherein the fixing structure and the strengthening glue are glues of the same material.

13. The touch device of claim 8, further comprising:
a mask layer, disposed on the second surface of the cover plate, wherein the vertical projection thereof onto the cover plate at least covers the vertical projection of the fingerprint recognition module onto the cover plate.

14. The touch device of claim 13, further comprising:
a shielding structure, located between the cover plate and the substrate and surrounding the fingerprint recognition module.

15. The touch device of claim 14, wherein the shielding structure is located between the first adhesive layer and the substrate.

16. The touch device of claim 14, wherein the shielding structure is located between the cover plate and the mask layer.

17. The touch device of claim 1, wherein the thickness of the cover plate is smaller than or equal to 0.3 mm.

18. The touch device of claim 8, wherein the cover plate has an indentation, and the orthographic projections of the indentation and the fingerprint recognition module onto the cover plate overlap.

19. The touch device of claim 18, wherein the indentation caves in from the first surface of the cover plate to the second surface of the cover plate.

20. The touch device of claim 19, wherein a depth from the first surface of the cover plate to the lowest point of the indentation is larger than or equal to 0.02 mm and smaller than or equal to 0.55 mm.

21. The touch device of claim 19, wherein a minimum distance from the lowest point of the indentation to the fingerprint recognition module is larger than or equal to 15μm and smaller than or equal to 550μm.
